(19) United States
(12) Patent Application Publication
(10) Pub. No.: US 2026/0343333 A1
(43) Pub. Date: Oct. 29, 2026

(54) RRM MOBILITY HANDLING BASED ON BEAM MANAGEMENT REPORTS

(71) Applicant: Telefonaktiebolaget LM Ericsson (publ), Stockholm (SE)

(72) Inventors: Dino PJANIC, Malmö (SE); Alexandros SOPASAKIS, Onsala (SE); Andres REIAL, Höllviken (SE)

(21) Appl. No.: 19/107,841

(22) PCT Filed: Sep. 6, 2023
(86) PCT No.: PCT/EP2023/074504

§ 371 Date: Feb. 28, 2025

Related U.S. Application Data
(60) Provisional application No. 63/404,282, filed on Sep. 7, 2022.

(51) Int. Cl. H04W 36/00

(52) U.S. Cl. CPC H04W 36/0058

(57) ABSTRACT

A method, system and apparatus are disclosed. A network node in communication with a wireless device in a first cell is provided. The network node is configured to receive, from the wireless device, a measurement report associated with the first cell. The network node is further configured to estimate at least one radio resource management, RRM, metric for the first cell and at least one second cell based on the measurement report and historical information. The network node is further configured to perform a RRM mobility procedure based on the estimated RRM metric.

### FIELD

The present disclosure relates to wireless communications, and in particular, to radio resource management (RRM) mobility handling based on beam management reports.

### INTRODUCTION

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WDs), as well as communication between network nodes and between wireless devices. Sixth Generation (6G) wireless communication systems are also under development.

### Conventional Radio Resource Management (RRM) Measurements and Reporting

In some existing systems, a wireless device may be configured with event-based reporting, where the wireless device transmits one or more RRM reports (e.g., triggered by events). The network node determines whether handover (HO) (also referred to as “handoff”) is necessary, and if so, triggers a HO.

### Machine Learning (ML)-Enhanced RRM Measurements

A wireless device may learn imminent event/HO situations based on previous RRM measurements. For example, during regular operation, the experience of learned RRM measurements for candidate cells and temporal sequences relationships is combined with current RRM measurements to improve (e.g., make more robust) RRM measurement and event reports.

### Conditional HO

In some existing systems, a wireless device may be configured with an RRM measurement condition for initiating a HO to another cell, and the cell may be informed by the current serving cell, e.g., network node, about an imminent HO. If the wireless device detects that the condition is satisfied, it autonomously accesses and connects to the new serving cell.

In conventional RRM measurements and reporting, HO may be triggered based on reported RRM mobility events that a wireless device directly observes and reports to the network node. This may in some scenarios lead to lack of robustness e.g., if the RRM measurement rate is relatively slow and the current link deteriorates rapidly before or around the time when the event is reported. The event signaling consumes uplink (UL) resources and creates interference in the network.

Using ML-enhanced RRM measurements, robustness may be improved, but full RRM measurements by the wireless device may still be necessary and the associated wireless device energy consumption is not reduced.

With conditional HO, reporting by the wireless device may be minimized but the full measurements continue, and the resulting HO robustness may be lower since the HO decision is taken by the wireless device based on one or a few individual measurements. RRM measurements in the wireless device remain unchanged.

Thus, existing systems lack configurations for robust and low overhead RRM mobility handling.

### SUMMARY

Aspects are provided by the independent claims, and embodiments thereof are provided in the dependent claims.

Some embodiments of the present disclosure advantageously provide methods, systems, and apparatuses for mobility handling where the HO decisions may be taken robustly/pro-actively, UL signaling for RRM is minimized, and/or where wireless device energy consumption due to RRM measurement is reduced, e.g., compared to existing systems.

For example, in some embodiments, during a learning phase of a ML model, a network node (e.g., gNB) may establish a relationship between Layer 1 (L1) (e.g., Open Systems Interconnection (OSI) Layer 1) reports (e.g., channel state information-reference signal (CSI-RS) for beam management (BM) (BM CSI-RS)) from its cell and corresponding RRM reports (e.g., Synchronization Signal Block (SSB)) for this and additional cells (e.g., by training an ML model). The training may be based on conventional wireless device event reports and/or extended RRM reporting during the learning phase and may be achieved, e.g., by training an ML model and/or preparing lookup tables.

For example, in some embodiments of the present disclosure, during regular operation, the network node (e.g., gNB) continually receives BM reports for the serving cell from a wireless device and uses these reports as input (e.g., to ML inference) to estimate RRM cell/beam quality metrics for the serving cell and/or other cells (e.g., neighboring cells). The network node thus may foresee mobility events for the wireless device, including, for example, the time remaining to an imminent event, and may proactively initiate a HO. The network node may set the internal HO trigger threshold, so the HO is triggered before the wireless device detects and reports the corresponding event.

In some embodiments, using the ML model approach for RRM metric prediction may include consideration of wireless device trajectory, which may result in better estimates, e.g., compared to individual event or other RRM measurement reporting.

In some embodiments, the wireless device may still be configured with conventional event-based reporting as a fallback, and to complement training data for ML model improvement, but with sparser measurement/reporting occasions to save wireless device energy and UL resources.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for RRM mobility handling based on beam management reports according to some embodiments of the present disclosure;

FIG. 8 is a flowchart of an example process in a wireless device for RRM mobility handling based on beam management reports according to some embodiments of the present disclosure;

FIGS. 9A and 9B are sequence diagrams of example procedures for RRM mobility handling based on beam management reports according to some embodiments of the present disclosure;

FIGS. 10A and 10B are sequence diagrams of example procedures for RRM mobility handling based on beam management reports according to some embodiments of the present disclosure;

FIG. 11 is a schematic illustrating an example scenario for RRM mobility handling based on beam management reports according to some embodiments of the present disclosure; and FIG. 12 is a flowchart of an example process in a network node for RRM mobility handling based on beam management reports according to some embodiments of the present disclosure.

### DETAILED DESCRIPTION

Before describing in detail example embodiments, it is noted that the embodiments reside primarily in combinations of apparatus components and processing steps related to RRM mobility handling based on beam management reports. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

It is also noted that references herein to cell measurements (or measurements of a cell) may refer to measurements of one or more network node signals of the one more network nodes serving the cell.

Some embodiments provide for RRM mobility handling based on beam management reports.

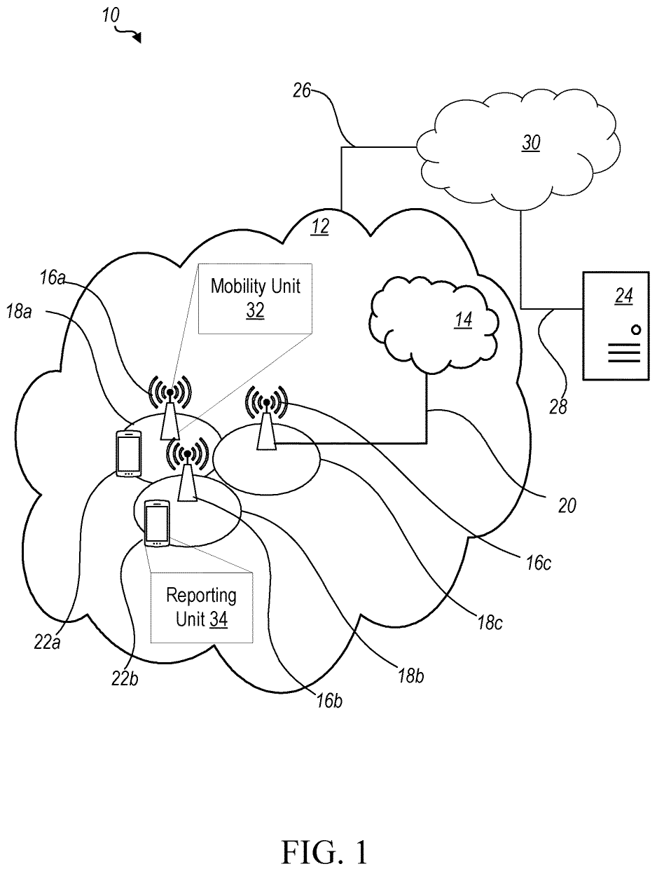

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a Mobility Unit 32 which is configured for RRM mobility handling based on beam management reports. A wireless device 22 is configured to include a Reporting Unit 34 which is configured for RRM mobility handling based on beam management reports.

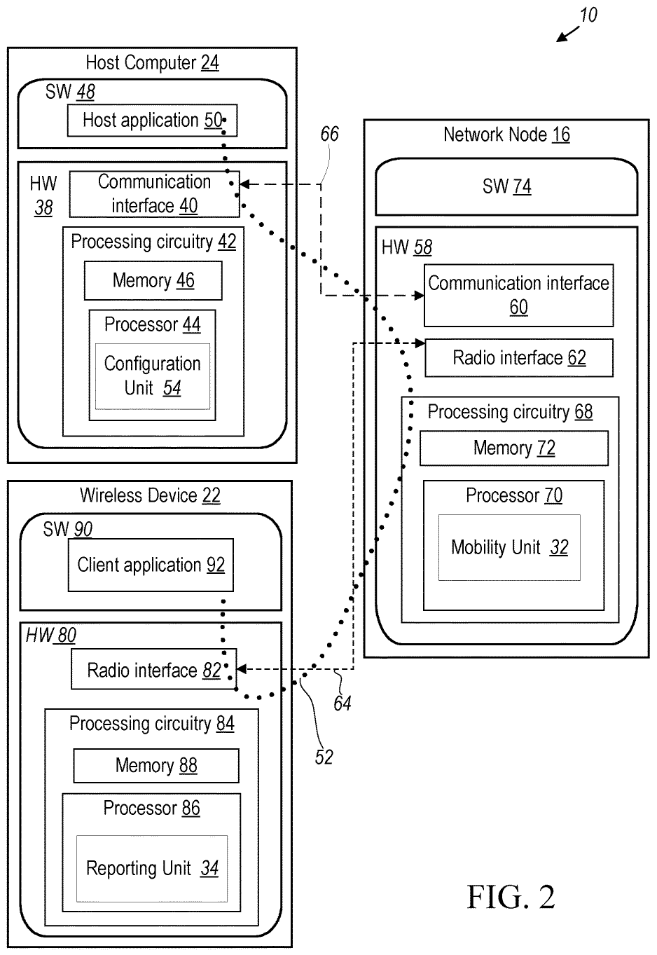

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a Configuration Unit 54 configured to enable the service provider to observe/monitor/control/transmit to/receive from/etc. the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include Mobility Unit 32 configured for RRM mobility handling based on beam management reports.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a Reporting Unit 34 configured for RRM mobility handling based on beam management reports.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16.

Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as Mobility Unit 32, and Reporting Unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

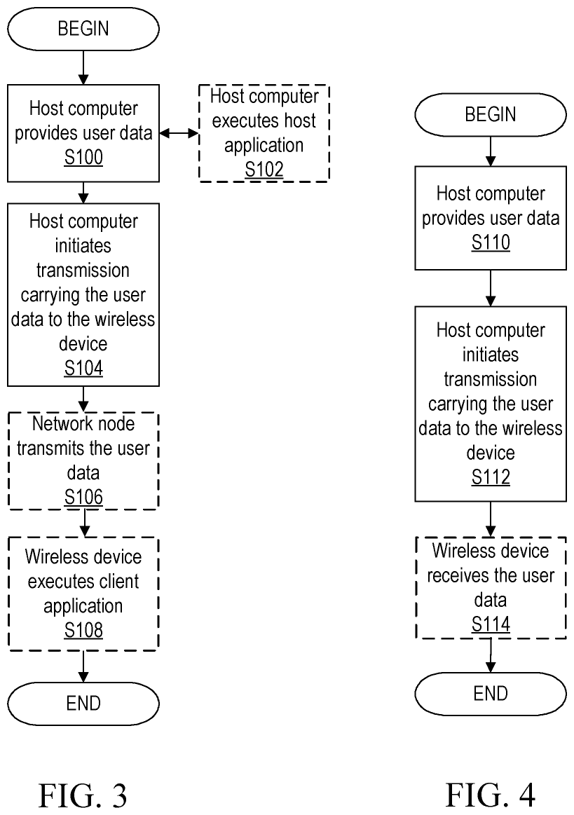

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

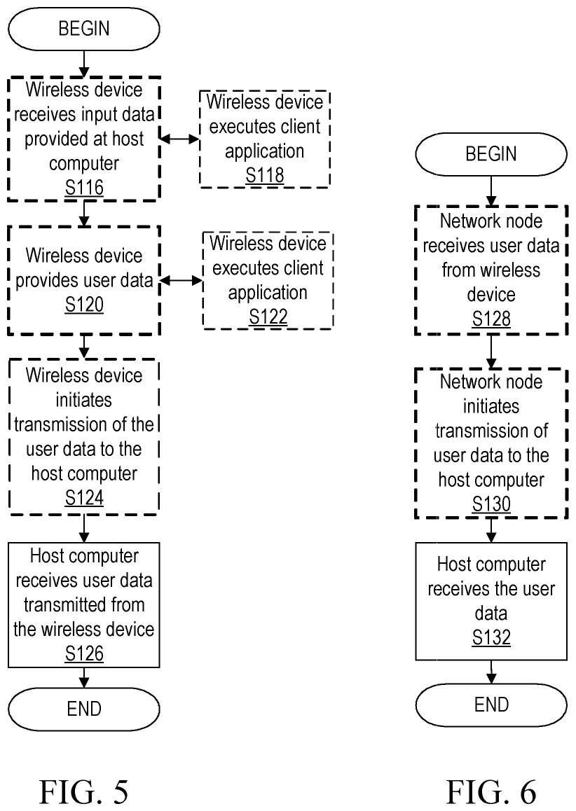

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

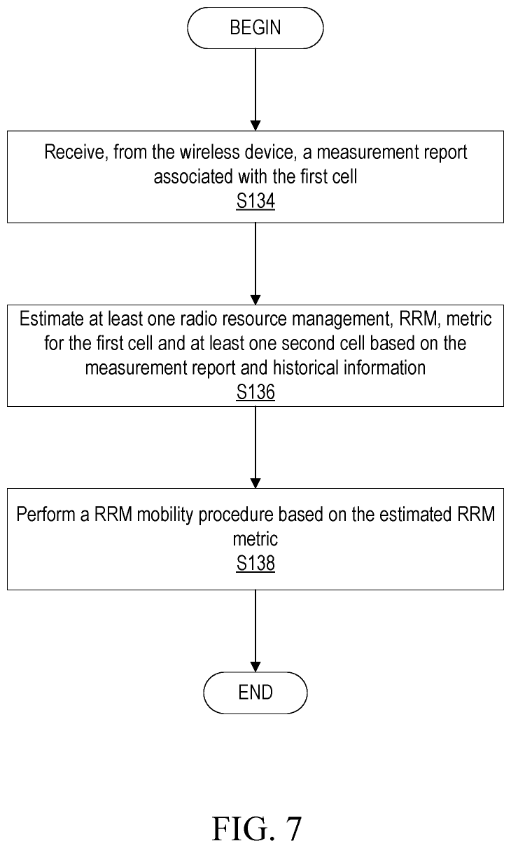

FIG. 7 is a flowchart of an example process in a network node 16 for RRM mobility handling based on beam management reports. One or more blocks described herein may be performed by one or more elements of network node 16 such as by one or more of processing circuitry 68 (including the Mobility Unit 32), processor 70, radio interface 62 and/or communication interface 60. Network node 16 is configured to receive (Block S134), from the wireless device 22, a measurement report associated with the first cell 18a. Network node 16 is configured to estimate (Block S136) at least one radio resource management, RRM, metric for the first cell 18a and at least one second cell 18b based on the measurement report and historical information. Network node 16 is configured to perform (Block S138) a RRM mobility procedure based on the estimated RRM metric.

In some embodiments, the first cell 18a is a serving cell, and the at least one second cell 18b includes a neighboring cell of the first cell 18a. In some embodiments, the historical information includes at least one of previously reported Layer, L1, measurements and/or beam management, BM, measurements associated with the first cell 18a and/or the at least one second cell 18b, and location information associated with at least one wireless device 22 in the first cell 18a and/or the at least one second cell 18b.

In some embodiments, the estimating of the at least one RRM metric is based on a machine learning, ML, model, where the ML is trained based on the historical information. In some embodiments, the network node 16 is further configured to determine location information associated with the wireless device 22, and the estimating of the at least one RRM metric is further based on the determined location information. In some embodiments, the network node 16 is further configured to configure the wireless device 22 with a RRM reporting configuration including and/or indicating a first event criterion, where the performing of the RRM mobility procedure is either initiated after the first event criterion is satisfied based on a fault and/or an emergency being detected (e.g., the particular type(s) of fault and/or emergency in this context may be determined based on the RRM reporting configuration and/or another configuration received by the network node 16 from another network node 16 and/or wireless device 22 and/or preconfigured in network node 16), or it is initiated before the first event criterion is satisfied based on the fault and/or the emergency not being detected. In some embodiments, the measurement report is based on at least one of beam management, BM, measurements, and Layer 1 (L1) quality measurements. In some embodiments, the performing of the RRM mobility procedure includes triggering a handover procedure from the first cell 18a to one of the at least one second cell 18b. In some embodiments, the measurement report does not include RRM measurements (e.g., the RRM measurement report is limited to non-RRM measurements).

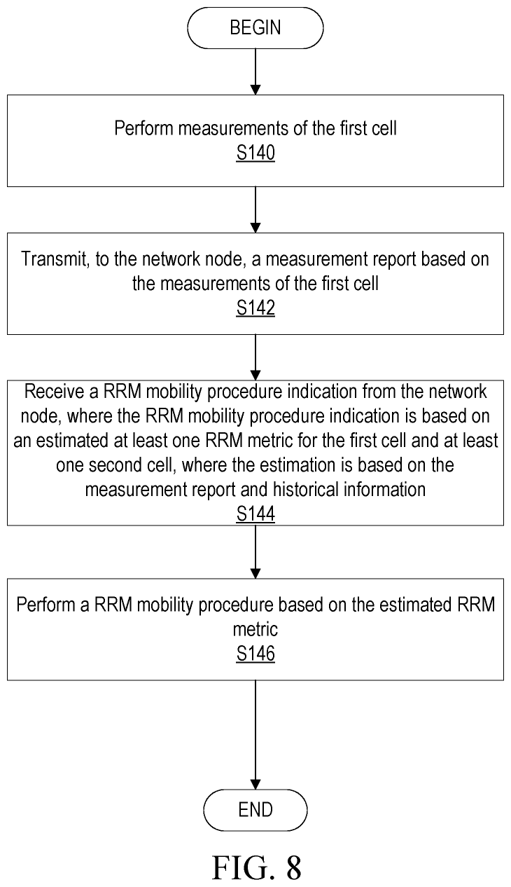

FIG. 8 is a flowchart of an example process in a wireless device 22 according to some embodiments of the present disclosure for RRM mobility handling based on beam management reports. One or more blocks described herein may be performed by one or more elements of wireless device 22 such as by one or more of processing circuitry 84 (including the Reporting Unit 34), processor 86, radio interface 82 and/or communication interface 60. Wireless device 22 is configured to perform measurements (Block S140) of the first cell 18a. Wireless device 22 is configured to transmit (Block S142), to the network node 22, a measurement report based on the measurements of the first cell 18a. Wireless device 22 is configured to receive (Block S144) a RRM mobility procedure indication from the network node 16, where the RRM mobility procedure indication is based on an estimated at least one RRM metric for the first cell 18a and at least one second cell 18b, where the estimation is based on the measurement report and historical information. Wireless device 22 is configured to perform (Block S146) a RRM mobility procedure based on the estimated RRM metric.

In some embodiments, the first cell 18a is a serving cell, and the at least one second cell 18b includes a neighboring cell of the first cell 18a. In some embodiments, the historical information includes at least one of previously reported Layer, L1, measurements and/or beam management, BM, measurements associated with the first cell 18a and/or the at least one second cell 18b, and location information associated with at least one wireless device 22 in the first cell 18a and/or the at least one second cell 18b.

In some embodiments, the estimation of the at least one RRM metric is based on a machine learning, ML, model, where the ML is trained based on the historical information. In some embodiments, the wireless device 22 is further configured to transmit location information associated with the wireless 22 device to the network node 16, where the estimation of the at least one RRM metric is further based on the location information.

In some embodiments, the wireless device 22 is further configured to receive, from the network node 16, a RRM reporting configuration including and/or indicating a first event criterion, where the performing of the RRM mobility procedure is either initiated after the first event criterion is satisfied based on a fault and/or an emergency being detected (e.g., the particular type(s) of fault and/or emergency in this context may be determined based on the RRM reporting configuration and/or another configuration received by the network node 16 and/or preconfigured in wireless device 22), or it is initiated before the first event criterion is satisfied based on the fault and/or the emergency not being detected. In some embodiments the measurement report is based on at least one of beam management, BM, measurements and Layer 1 (L1) quality measurements. In some embodiments, the performing of the RRM mobility procedure includes performing a handover procedure from the first cell 18a to one of the at least one second cell 18b. In some embodiments, the measurement report does not include RRM measurements (e.g., the RRM measurement report is limited to non-RRM measurements).

Having described the general process flow of arrangements of the disclosure and having provided examples of hardware and software arrangements for implementing the processes and functions of the disclosure, the sections below provide details and examples of arrangements for RRM mobility handling based on beam management reports.

For example, embodiments of the present disclosure provide a method implemented in a network node 16 for RRM HO handling. The method includes determining a first relationship (e.g., training a ML model) between one or more first L1 quality reports for a first cell and one or more first RRM quality reports for the first cell 18a and one or more second cell(s) 18b, receiving one or more second L1 quality reports from a wireless device 22, estimating a second RRM quality metric for the first cell 18a and the (one or more) second cell 18b for the wireless device 22, based on the second L1 quality reports and the first relationship, and triggering a HO procedure from the first to the second cell for the wireless device 22, e.g., based on the second RRM quality metric.

Optionally, the wireless device 22 may be provided (e.g., by network node 16) with an RRM reporting configuration including, e.g., a first event criterion, where the triggering includes initiating the HO procedure before the first event criterion is satisfied.

Some embodiments of the present disclosure may advantageously provide a network node 16 (e.g., gNB) which triggers HOs without necessarily receiving event reports and/or candidate cell 18 SSB quality reports, while receiving BM reports.

Some embodiments of the present disclosure may allow for one or more advantages that may not be possible with existing methods and systems, for example:
Pro-active HO triggering, e.g., according to one or more embodiments of the present disclosure, may improve mobility robustness;
Prediction of time remaining to HO and initiating early preparations may reduce the time required for the actual HO procedure;
Minimal event reporting may reduce interference in the UL and/or reduce UL resource usage; and
Reduced wireless device 22 RRM measurements and/or reduced and/or no reporting provides wireless device 22 energy savings.

In some embodiments of the present disclosure, the network node 16 (e.g., gNB) may utilize a relationship wherein multiple measurement procedures in the same environment may typically provide related results, e.g., BM and RRM mobility measurements in a certain location may provide mutually consistent and/or correlated outputs. Therefore, when previous info about their relationship is available, e.g., RRM measurement results may be predicted or estimated based on BM measurements in the same region, as the BM measurements may provide a higher-resolution spatial resolution from which the lower-resolution RRM-related info can be extracted.

Based on this relationship, the network node 16 (e.g., gNB) may not require detailed RRM measurement info and instead may base the RRM decisions on BM measurements reported by the wireless device 22. The wireless device 22 may then use prior information about the BM and RRM relations to estimate the corresponding RRM measurement results and may use those estimates as inputs to an RRM procedure, e.g., an RRM procedure according to known methods, or a modified RRM procedure as described herein.

While in principle, according to some embodiments of the present disclosure, the RRM measurements and reports may be completely dispensed with, some embodiments of the present disclosure (e.g., in practical implementations) may nevertheless configure the wireless device 22 with some RRM measurements and reporting, and/or other procedures like conditional HO. For example, in at least one embodiment, the events and conditions may nevertheless be set so that they are typically not (e.g., rarely) triggered, but may serve as a safety net in addition to the pre-trained RRM event prediction, e.g., event A3 (for example, where a neighbor cell 18b becomes better than an offset relative to the serving cell 18a). This may provides wireless device 22 energy savings from reduced event reporting and/or from reduced RRM measurements.

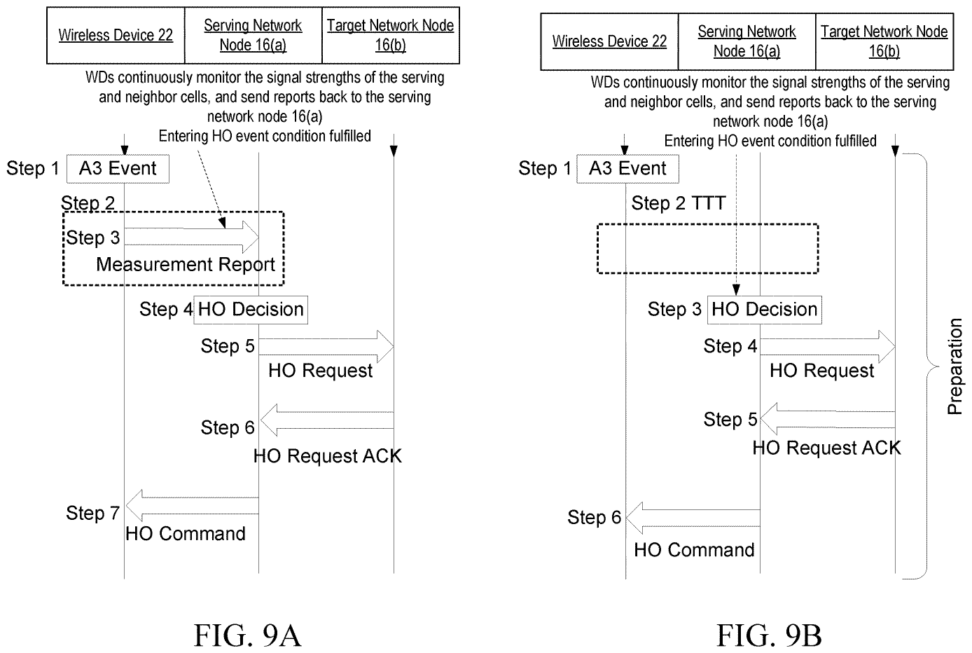

FIG. 9A and FIG. 9B depict sequence diagrams illustrating two example embodiments of the present disclosure.

In the example illustrated in FIG. 9A, a wireless device 22 is in communication with a serving network node 16a and a target network node 16b (e.g., serving base station and target base station). The wireless device 22 monitors (e.g., continuously, periodically, etc.) the signal strength(s) of the serving cell 18a and the neighboring cells 18b, 18c, etc., and the wireless device 22 sends reports to the serving network node 16a. In Step 1, an A3 event occurs/is triggered. In Step 2, a time-to-trigger (TTT), which may, for example, be configured at the wireless device 22 and/or configured by the network node 16, elapses. Once the time has elapsed, in Step 3, the wireless device 22 transmits a measurement report to the serving network node 16a. In Step 4, the serving network node 16a determines a HO decision. In Step 5, based on the determination the serving network node 16a transmits a HO request to the target network node 16b. In Step 6, the target network node 16b responds to the serving network node 16a with a HO request acknowledgment (ACK). In Step 7, the serving network node 16a transmits a HO command to the wireless device 22.

In the example illustrated in FIG. 9B, a wireless device 22 is in communication with a serving network node 16a and a target network node 16b (e.g., serving base station and target base station). The wireless device 22 monitors (e.g., continuously, periodically, etc.) the signal strength(s) of the serving cell 18a and the neighboring cells 18b, 18c, etc., and the wireless device 22 sends reports to the serving network node 16a. In Step 1, an A3 event occurs/is triggered. In Step 2, a time-to-trigger (TTT), which may, for example, be configured at the wireless device 22 and/or configured by the network node 16, elapses. Unlike in the example of FIG. 9A, the example of FIG. 9B may not include the wireless device 22 sending a measurement report to the serving network node 16a. In Step 3, of FIG. 9B, the serving network node 16a determines a HO decision (e.g., based on a ML model). In Step 4, based on the determination the serving network node 16a transmits a HO request to the target network node 16b. In Step 5, the target network node 16b responds to the serving network node 16a with a HO request acknowledgment (ACK). In Step 6, the serving network node 16a transmits a HO command to the wireless device 22.

In some embodiments of the present disclosure, the BM measurement info may alternatively or additionally be used to predict the mobility event occurrence time and the HO procedure may be pre-initiated, which in some cases may result in a shorter transition time.

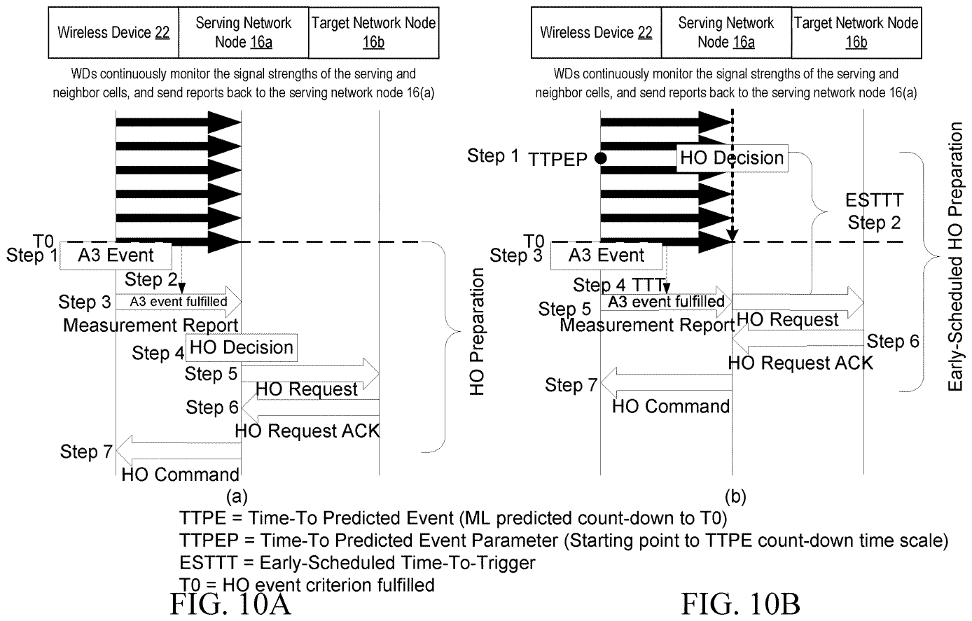

FIG. 10A and FIG. 10B are sequence diagrams illustrating example embodiments of the present disclosure.

In the example illustrated in FIG. 10A, during the 3GPP preparation stage of the legacy 5G handover procedure, the wireless device 22 measures the signals of the serving cell 18a and neighbor cells 18b, 18c, etc., and evaluates whether any of the measured signals satisfy the entering criterion of the HO event. Prior to a time TO, the wireless device 22 monitors (e.g., continuously, periodically, etc.) the signal strengths of the serving cell 18a and the neighbor cells 18b, 18c, etc., and sends reports back to the serving network node 16a. In Step 1, at time TO, the A3 Event occurs. In Step 2, the TTT timer elapses. In Step 3, the A3 Event fulfilled message is transmitted from the wireless device 22 to the serving network node 16a, which may include a measurement report. In Step 4, the serving network node 16a determines a HO decision. In Step 5, the serving network node 16a transmits an HO request to the target network node 16b. In Step 5, the target network node 16b transmits an HO Request ACK to the serving network node 16a. In Step 7, the serving network node 16a transmits an HO command to the wireless device 22.

In the example illustrated in FIG. 10B, reduced total HO processing time may be achieved by early-triggering of HO decision process using configurable, ML-empowered Time To Event Criterion Fulfillment (TTECF) parameter (sometimes referred to as Time To Predicted Event Parameter (TTPEP) which indicates predicted starting point for countdown to T0 where the HO event criterion is fulfilled) (Step 1) which determines the starting point of an early evaluation, which in the drawings is indicated as Early-Scheduled Evaluation Time Frame (ESETF) through dotted arrow, ahead of actual A3 event condition fulfillment at T0 time. Prior to a time T0, the wireless device 22 monitors (e.g., continuously, periodically, etc.) the signal strengths of the serving cell 18a and the neighbor cells 18b, 18c, etc., and sends reports back to the serving network node 16a. In Step 1, prior to time T0, the TTECF parameter, which is determined based on an ML-model, begins to elapse. In Step 2, the serving network node 16a determines a HO decision. At time T0 (Step 3), A3 Event occurs. In Step 4, the TTT timer elapses. In Step 5, the A3 Event fulfilled message is transmitted from the wireless device 22 to the serving network node 16a, which may include a measurement report, and the serving network node 16a transmits an HO request to the target network node 16b (e.g., as a continuation of Step 2). In Step 6, the target network node 16b transmits an HO Request ACK to the serving network node 16a. In Step 7, the serving network node 16a transmits an HO command to the wireless device 22.

In some embodiments, the RRM and BM measurements may pertain to the same band or Frequency Range (FR), or may pertain to different bands/FRs, e.g., FR2 BM results may be used to control FR1 RRM mobility. The mapping of FR BM results to FR RRM mobility (e.g., FR3 BM results are used to control FR1 RRM mobility, FR4 BM results are used to control FR2 RRM mobility, etc.) may be configured, e.g., at and/or by the network node 16 and/or wireless device 22.

In some embodiments, the RRM event prediction may be based on a previously learned relationship between BM measurements on the serving cell 18a and RRM mobility measurements for serving cell 18a and candidate cells 18b, 18c, etc., such as in a certain location or along a certain route (e.g., a roadway). The learning may be implemented by training, e.g., a fingerprinting-based ML model, and the estimates of RRM results in online operation may be derived from inference using that model.

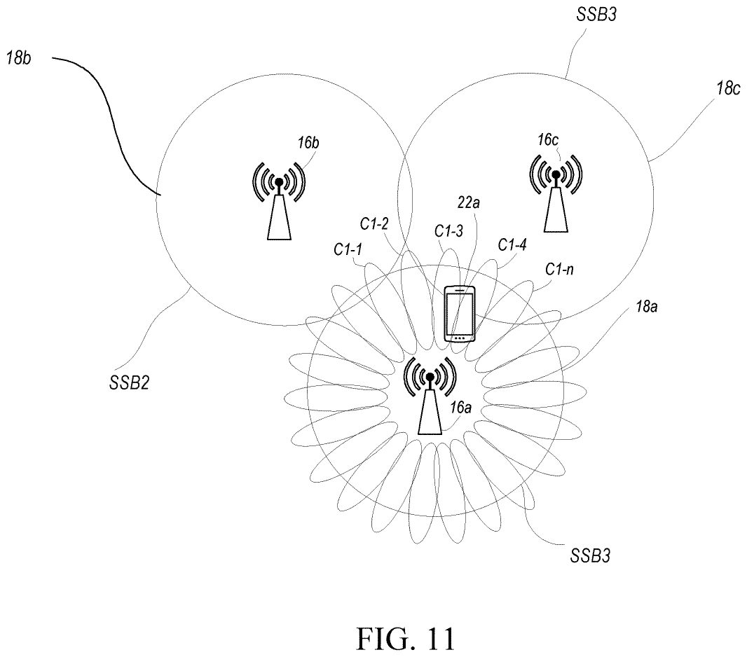

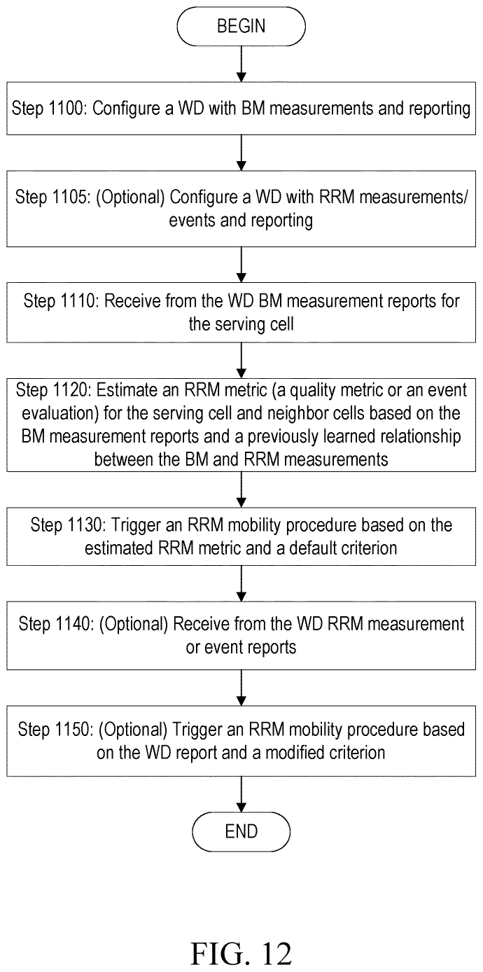

FIG. 11 illustrates an example of BM-RRM relationships according to some embodiments of the present disclosure. In the RRM mobility measurement domain, the wireless device 22 in a certain position in its serving cell 18a may be associated with SSB measurements (e.g., RSRP) for cells 18a, 18b, and 18c. Simultaneously, in the BM measurement domain, the wireless device 22 is also associated with multiple CSI-RS metrics (e.g., L1-RSRP) in cell 18a. In some embodiments, the RRM mobility and BM measurement fingerprints for the wireless device 22 may be unique and/or discernible in different parts of the cell 18, and a certain RRM fingerprint can be linked to a BM fingerprint.

In the example of FIG. 11, a single SSB per cell is assumed, but it is to be understood that multiple SSBs may also be used in accordance with embodiments of the present disclosure, e.g., which may create some spatial resolution which may be still coarser than captured from CSI-RS measurements.

FIG. 12 is a flow chart illustrating an example process flow in a network node 16 (e.g., gNB) according to some embodiments of the present disclosure (e.g., where the procedure is transparent to the wireless device 22). Some embodiments of the present disclosure may provide a method in a network node 16 node for RRM HO handling, including, for example, determining a first relationship between first L1 quality reports for a first cell 18a and first RRM quality reports for the first cell 18a and one or more second cells 18b. One or more second L1 quality reports may be received from a wireless device 22. A second RRM quality metric may be estimated for the first cell 18a and the (one or more) second cell 18b for the wireless device 22, based on the second L1 quality reports and the first relationship. The network node 16a may trigger a HO procedure from the first cell 18a to the second cell 18b for the wireless device 22, based on the second RRM quality metric. In some embodiments, the network node 16 (and/or some other network entity, such as host computer 24) provides the wireless device 22 with an RRM reporting configuration including a first event criterion. The triggering may include initiating the HO procedure before the first event criterion is satisfied.

### Deduction of RRM Mobility Events

Referring to FIG. 12, in step 1100, the network node 16a (e.g. the serving gNB), configures the wireless device 22 for BM procedures, optionally including one or more of CSI-RS resource description, a measurement schedule, reporting criterion descriptions, reporting signaling configuration, etc. The BM configuration may be equivalent to legacy BM configuration or it may be extended to obtain BM CSI-RS measurement reports with higher resolution and/or more frequently.

In step 1110, the network node 16 receives wireless device 22 reports from BM L1 measurements (or in general, measurements with higher spatial resolution), according to a separately provided BM measurement configuration. The measurements may use, e.g., CSI-RS with resources included in the BM measurement configuration in step 1110.

In step 1120, the network node 16 uses previously established/measured/received/determined/etc. information about the relation of BM and RRM measurement results for different possible wireless device 22 locations to derive/estimate/predict the relevant RRM metrics from the BM measurement reports. In one embodiment, the network node 16 may estimate RRM measurement results for the serving cell 18a and additional neighbor cells 18b, 18c, etc. In some embodiments, the wireless device 22 may estimate the occurrence of RRM events (e.g., reporting events or conditional HO trigger events) according to conventional/default/legacy HO criteria.

In some embodiments, the derivation/estimation may be in the form of performing ML inference using a previously trained ML model. More details about how such a model can be prepared/generated/determined/configured/trained/etc. are provided herein.

Referring still to FIG. 12, in step 1130, the network node 16 uses the estimated RRM metrics to trigger execution of conventional RRM mobility procedures, e.g., triggering a HO. The criterion or threshold used for this triggering may be same or comparable/equivalent to legacy criteria used for mobility management. In one embodiment, the network node 16 may detect that an event has occurred and respond immediately and accordingly. In another embodiment, the network node 16 may detect that an event is imminent and predict the time remaining to the event. The network node 16 may then initiate appropriate preparations, e.g., preparation for a HO procedure including inter-network node 16 (e.g., inter-gNB) signaling, buffer contents or signal flow duplication, etc.

Note that steps 1100, 1110, and 1130 may include procedures similar to procedures executed in legacy implementations, while in some embodiments, configurations of these procedures may be modified, e.g., to make them more suitable for utilizing the learned BM-RRM relationships.

### Conventional RRM Mobility Underlay

Embodiments of the present disclosure may includes an optional second aspect where the wireless device 22 may be configured with conventional RRM procedures, e.g., measurements, reporting, and/or mobility events, as a backup or fallback mechanism, to improve the robustness of the learning-based approach.

Referring still to FIG. 12, in an optional step 1105, the network node 16 also configures the wireless device 22 for RRM mobility procedures, optionally including one or more of RRM measurement object description (e.g., SSBs in the serving cell 18a and neighbor cells 18b, 18c, etc.), measurement schedule, reporting event/criterion descriptions, reporting signaling configuration, conditional HO configurations, etc. The configuration may be determined/selected/etc. so that, e.g., mobility events may be triggered later than in conventional/legacy mobility/HO configurations.

In an optional step 1140, the network node 16 receives RRM reports from the wireless device 22 according to the configuration in step 1105 and in step 1150, the network node 16 may trigger RRM mobility procedures, e.g., a HO, based on the reports. Steps 1140-1150 may differ from conventional operation since the reports may be received and/or procedures may be triggered only when the need for, e.g., HO is more urgent (e.g., based on one or more conditions/indications indicating a high priority/urgency HO). This may serve as a safety net since, under normal conditions, steps 1120-1130 may ensure that required procedures are triggered based on conventional inter-cell quality criteria and steps 1140-1150 may only take effect if steps 1120-1130 did not react appropriately, e.g., due to data drift with regard to a previously trained ML model.

In some embodiments, a wireless device configured with conventional conditional HO configurations would be correspondingly triggered.

### ML Model Training

In some embodiments, the network node 16 ML model (e.g., as used in step 1120 of FIG. 12) may be prepared by training it with measurement data from past/historic measurement occasions. RRM measurement results for the current cell 18a and/or neighbor cells 18b, 18c, etc., and BM measurement results for the current cell 18a are used as training data and the model is trained, e.g., to minimize a loss function between the observed and estimated RRM measurement results for the serving and neighbor cells when the BM measurement values are provided as input. Alternatively, or additionally, the training may be configured so that the ML model generates event trigger signals for, e.g., event reporting and/or conditional HO initiation.

In one set of embodiments, the network node 16 ML model may be trained cell-specifically. This can be achieved, e.g., by collecting BM reports and RRM mobility reports from wireless device 22 in a cell 18a which are used to train a cell-specific model representing BM-to-RRM metric mapping for the cell 18, where measurements and ML models are associated with corresponding cells 18.

In one embodiment, offline training is used, e.g., a training performed at the network node 16 vendor location, or locally in the network node 16. In another embodiment, online training is used where the network node 16 collects current BM and RRM mobility measurements and trains or retrains the model for improved RRM measurement estimation. A combination of offline training and online training may be utilized.

### Example Scenario in Accordance With Embodiments of the Present Disclosure

For example, in one scenario, such as a legacy setup, the wireless device 22 may be configured with RRM measurements on every 40 ms and a mobility event, causing a report to the serving network node 16a to be triggered if the difference between serving cell 18a and candidate cell 18b RSRP is less than 3 dB. The wireless device 22 may thus perform measurements at the 40 ms rate and report cases where a candidate cell 18b is within 3 dB or less of the serving cell 18a, and the network node 16a may determine that the wireless device 22 should perform a HO to such a candidate cell 18b once the reported or otherwise estimated difference is less than 0 dB (i.e., the candidate cell 18b becomes stronger than the current serving cell 18a).

In some embodiments of the present disclosure, the wireless device 22 may be configured with BM measurements every 40 ms, with continuous best beam and/or additional beam L1-RSRP reporting. The wireless device 22 may not be configured with RRM mobility reporting. Using a previously trained ML model, the network node 16 uses the wireless device 22 BM reports to determine that a mobility event corresponding to a certain serving cell 18a/candidate cell 18b RSRP relationship would have occurred. Based on the estimated event, the network node 16 may triggers a HO to the candidate cell 18b.

This scenario may illustrate advantages of embodiments of the present disclosure, for example, that (1) the wireless device 22 does not need to perform RRM measurements, (2) the wireless device 22 does not need to perform event reporting, and/or (3) the HO decisions may be taken based on measurement data with higher spatial resolution.

In some embodiments, the wireless device 22 may be additionally configured with RRM mobility measurements every 120 ms and a mobility event, causing a report to the serving network node 16 to be triggered if the difference between serving cell 18a and candidate cell 18b RSRP is less than −1 dB (i.e., the candidate cell 18b becomes at least 1 dB stronger than the current serving cell 18a).

In some embodiments, for example, (1) the wireless device 22 performs less frequent RRM measurements (e.g., as compared to existing systems) and/or (2) the wireless device 22 only performs event reporting if the BM-based reports did not result in a HO when the legacy event level was reached, which only occurs in exceptional circumstances. The improved spatial resolution of the measurements may be maintained and a safety net (i.e., fallback/default backup procedure) is additionally provided.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

### EMBODIMENTS

Embodiment A1. A network node configured to communicate with a wireless device in a first cell, the network node configured to, and/or comprising a radio interface and/or comprising processing circuitry configured to:
receive, from the wireless device, a measurement report associated with the first cell;
estimate at least one radio resource management, RRM, metric for the first cell and at least one second cell based on the measurement report and historical information; and
perform a RRM mobility procedure based on the estimated RRM metric.

Embodiment A2. The network node of Embodiment A1, wherein the first cell is a serving cell, the at least one second cell including a neighboring cell of the first cell.

Embodiment A3. The network node of any one of Embodiments A1 and A2, wherein the historical information includes at least one of:
previously reported Layer, L1, measurements and/or beam management, BM, measurements associated with the first cell and/or the at least one second cell; and
location information associated with at least one wireless device in the first cell and/or the at least one second cell.

Embodiment A4. The network node of any one of Embodiments A1-A3, wherein the estimating of the at least one RRM metric is based on a machine learning, ML, model, the ML being trained based on the historical information.

Embodiment A5. The network node of Embodiment A4, wherein the network node is further configured to:
determine location information associated with the wireless device; and
the estimating of the at least one RRM metric being further based on the determined location information.

Embodiment A6. The network node of any one of Embodiments A1-A5, wherein the network node is further configured to configure the wireless device with a RRM reporting configuration including and/or indicating a first event criterion, the performing of the RRM mobility procedure being one of:
initiated after the first event criterion is satisfied based on a fault and/or an emergency being detected; and
initiated before the first event criterion is satisfied based on the fault and/or the emergency not being detected.

Embodiment A7. The network node of any one of Embodiments A1-A6, wherein the measurement report is based on at least one of:
beam management, BM, measurements; and
Layer 1 (L1) quality measurements.

Embodiment A8. The network node of any one of Embodiments A1-A7, wherein the performing of the RRM mobility procedure includes triggering a handover procedure from the first cell to one of the at least one second cell.

Embodiment A9. The network node of any one of Embodiments A1-A8, wherein the measurement report does not include RRM measurements.

Embodiment B1. A method implemented in a network node configured to communicate with a wireless device in a first cell, the method comprising:
receiving (Block S134), from the wireless device, a measurement report associated with the first cell;
estimating (Block S136) at least one radio resource management, RRM, metric for the first cell and at least one second cell based on the measurement report and historical information; and
performing (Block S138) a RRM mobility procedure based on the estimated RRM metric.

Embodiment B2. The method of Embodiment B1, wherein the first cell is a serving cell, the at least one second cell including a neighboring cell of the first cell.

Embodiment B3. The method of any one of Embodiments B1 and B2, wherein the historical information includes at least one of:
previously reported Layer, L1, measurements and/or beam management, BM, measurements associated with the first cell and/or the at least one second cell; and
location information associated with at least one wireless device in the first cell and/or the at least one second cell.

Embodiment B4. The method of any one of Embodiments B1-B3, wherein the estimating of the at least one RRM metric is based on a machine learning, ML, model, the ML being trained based on the historical information.

Embodiment B5. The method of Embodiment B4, further comprising:
determining location information associated with the wireless device; and the estimating of the at least one RRM metric being further based on the determined location information.

Embodiment B6. The method of any one of Embodiments B1-B5, the method further comprising configuring the wireless device with a RRM reporting configuration including and/or indicating a first event criterion, the performing of the RRM mobility procedure being one of:
initiated after the first event criterion is satisfied based on a fault and/or an emergency being detected; and
initiated before the first event criterion is satisfied based on the fault and/or the emergency not being detected.

Embodiment B7. The method of any one of Embodiments B1-B6, wherein the measurement report is based on at least one of:
beam management, BM, measurements; and
Layer 1 (L1) quality measurements.

Embodiment B8. The method of any one of Embodiments B1-B7, wherein the performing of the RRM mobility procedure includes triggering a handover procedure from the first cell to one of the at least one second cell.

Embodiment B9. The method of any one of Embodiments B1-B8, wherein the measurement report does not include RRM measurements.

Embodiment C1. A wireless device configured to communicate with a network node in a first cell, the configured to, and/or comprising a radio interface and/or processing circuitry configured to:
perform measurements of the first cell;
transmit, to the network node, a measurement report based on the measurements of the first cell;
receive a radio resource management, RRM, mobility procedure indication from the network node, the RRM mobility procedure indication being based on an estimated at least one RRM metric for the first cell and at least one second cell, the estimation being based on the measurement report and historical information; and
perform a RRM mobility procedure based on the estimated RRM metric.

Embodiment C2. The wireless device of Embodiment C1, wherein the first cell is a serving cell, the at least one second cell including a neighboring cell of the first cell.

Embodiment C3. The wireless device of any one of Embodiments C1 and C2, wherein the historical information includes at least one of:
previously reported Layer, L1, measurements and/or beam management, BM, measurements associated with the first cell and/or the at least one second cell; and
location information associated with at least one wireless device in the first cell and/or the at least one second cell.

Embodiment C4. The wireless device of any one of Embodiments C1-C3, wherein the estimation of the at least one RRM metric is based on a machine learning, ML, model, the ML being trained based on the historical information.

Embodiment C5. The wireless device of Embodiment C4, wherein the wireless device is further configured to:
transmit location information associated with the wireless device to the network node, the estimation of the at least one RRM metric being further based on the location information.

Embodiment C6. The wireless device of any one of Embodiments C1-C5, wherein the wireless device is further configured to receive, from the network node, a RRM reporting configuration including and/or indicating a first event criterion, the performing of the RRM mobility procedure being one of:
initiated after the first event criterion is satisfied based on a fault and/or an emergency being detected; and
initiated before the first event criterion is satisfied based on the fault and/or the emergency not being detected.

Embodiment C7. The wireless device of any one of Embodiments C1-C6, wherein the measurement report is based on at least one of:
beam management, BM, measurements; and
Layer 1 (L1) quality measurements.

Embodiment C8. The wireless device of any one of Embodiments C1-C7, wherein the performing of the RRM mobility procedure includes performing a handover procedure from the first cell to one of the at least one second cell.

Embodiment C9. The wireless device of any one of Embodiments C1-C8, wherein the measurement report does not include RRM measurements.

Embodiment D1. A method implemented in a wireless device configured to communicate with a network node in a first cell, the method comprising:
performing (Block S140) measurements of the first cell;
transmitting (Block S142), to the network node, a measurement report based on the measurements of the first cell;
receiving (Block S144) a radio resource management, RRM, mobility procedure indication from the network node, the RRM mobility procedure indication being based on an estimated at least one RRM metric for the first cell and at least one second cell, the estimation being based on the measurement report and historical information; and
performing (Block S146) a RRM mobility procedure based on the estimated RRM metric.

Embodiment D2. The method of Embodiment D1, wherein the first cell is a serving cell, the at least one second cell including a neighboring cell of the first cell.

Embodiment D3. The method of any one of Embodiments D1 and D2, wherein the historical information includes at least one of:
previously reported Layer, L1, measurements and/or beam management, BM, measurements associated with the first cell and/or the at least one second cell; and
location information associated with at least one wireless device in the first cell and/or the at least one second cell.

Embodiment D4. The method of any one of Embodiments D1-D3, wherein the estimation of the at least one RRM metric is based on a machine learning, ML, model, the ML being trained based on the historical information.

Embodiment D5. The method of Embodiment D4, wherein the method further comprises transmitting location information associated with the wireless device to the network node, the estimation of the at least one RRM metric being further based on the location information.

Embodiment D6. The method of any one of Embodiments D1-D5, wherein the method further comprises receiving, from the network node, a RRM reporting configuration including and/or indicating a first event criterion, the performing of the RRM mobility procedure being one of:
initiated after the first event criterion is satisfied based on a fault and/or an emergency being detected; and
initiated before the first event criterion is satisfied based on the fault and/or the emergency not being detected.

Embodiment D7. The method of any one of Embodiments D1-D6, wherein the measurement report is based on at least one of:
beam management, BM, measurements; and
Layer 1 (L1) quality measurements.

Embodiment D8. The method of any one of Embodiments D1-D7, wherein the performing of the RRM mobility procedure includes performing a handover procedure from the first cell to one of the at least one second cell.

Embodiment D9. The method of any one of Embodiments D1-D8, wherein the measurement report does not include RRM measurements.

1. A network node configured to communicate with a wireless device in a first cell, the network node comprising a radio interface and processing circuitry configured to:
receive, from the wireless device, a measurement report associated with the first cell;
estimate at least one radio resource management, RRM, metric for the first cell and at least one second cell based on the measurement report and historical information, the measurement report being based on beam management, BM, measurements and Layer 1, L1, quality measurements, and the historical information including previously reported Layer, L1, measurements and beam management, BM, measurements associated with the first cell and let at least one second cell; and
perform a RRM mobility procedure based on the estimated RRM metric, the performing of the RRM mobility procedure including triggering a handover procedure from the first cell to one of the at least one second cell.

2. (canceled)

3. The network node of claim 1, wherein the historical information includes:
location information associated with at least one wireless device in one or both of the first cell and the at least one second cell.

4. (canceled)

5. The network node of claim 3, wherein the network node is further configured to:
determine location information associated with the wireless device; and
the estimating of the at least one RRM metric being further based on the determined location information.

6.-8. (canceled)

9. The network node of claim 1, wherein the measurement report does not include RRM measurements.

10. A method implemented in a network node configured to communicate with a wireless device in a first cell, the method comprising:
receiving from the wireless device, a measurement report associated with the first cell;
estimating at least one radio resource management, RRM, metric for the first cell and at least one second cell based on the measurement report and historical information, the measurement report being based on beam management, BM, measurements and Layer 1, L1, quality measurements, the historical information including previously reported Layer, L1, measurements and beam management, BM, measurements associated with the first cell and the at least one second cell; and
performing a RRM mobility procedure based on the estimated RRM metric, the performing of the RRM mobility procedure including triggering a handover procedure from the first cell to one of the at least one second cell.

11. (canceled)

12. The method of claim 10, wherein the historical information includes:
location information associated with at least one wireless device in one or both of the first cell and the at least one second cell.

13. (canceled)

14. The method of claim 12, further comprising:
determining location information associated with the wireless device; and
the estimating of the at least one RRM metric being further based on the determined location information.

15.-17. (canceled)

18. The method of claim 10, wherein the measurement report does not include RRM measurements.

19. A wireless device configured to communicate with a network node in a first cell, the wireless device comprising a radio interface and processing circuitry configured to:
perform measurements of the first cell;
transmit, to the network node, a measurement report based on the measurements of the first cell;
receive a radio resource management, RRM, mobility procedure indication from the network node, the RRM mobility procedure indication being based on an estimated at least one RRM metric for the first cell and at least one second cell, the estimation being based on the measurement report and historical information, the measurement report being based on beam management, BM, measurements and Layer 1, L1, quality measurements, and the historical information including previously reported Layer, L1, measurements and beam management, BM, measurements associated with the first cell and the at least one second cell; and
perform a RRM mobility procedure based on the estimated RRM metric, the performing of the RRM mobility procedure including performing a handover procedure from the first cell to one of the at least one second cell.

20. The wireless device of claim 19, wherein the first cell is a serving cell, the at least one second cell including a neighboring cell of the first cell.

21. The wireless device of claim 19, wherein the historical information includes:
location information associated with at least one wireless device in one or both of the first cell and the at least one second cell.

22. (canceled)

23. The wireless device of claim 21, wherein the wireless device is further configured to:
transmit location information associated with the wireless device to the network node, the estimation of the at least one RRM metric being further based on the location information.

24.-26. (canceled)

27. The wireless device of claim 19, wherein the measurement report does not include RRM measurements.

28. A method implemented in a wireless device configured to communicate with a network node in a first cell, the method comprising:
performing measurements of the first cell;
transmitting to the network node, a measurement report based on the measurements of the first cell;
receiving a radio resource management, RRM, mobility procedure indication from the network node, the RRM mobility procedure indication being based on an estimated at least one RRM metric for the first cell and at least one second cell, the estimation being based on the measurement report and historical information, the measurement report being based on beam management, BM, measurements and Layer 1, L1, quality measurements, and the historical information including previously reported Layer, L1, measurements and beam management, BM, measurements associated with the first cell and the at least one second cell; and
performing a RRM mobility procedure based on the estimated RRM metric, the performing of the RRM mobility procedure including performing a handover procedure from the first cell to one of the at least one second cell.

29. The method of claim 28, wherein the first cell is a serving cell, the at least one second cell including a neighboring cell of the first cell.

30. The method of claim 28, wherein the historical information includes:
location information associated with at least one wireless device in one or both of the first cell and the at least one second cell.

31. (canceled)

32. The method of claim 30, wherein the method further comprises transmitting location information associated with the wireless device to the network node, the estimation of the at least one RRM metric being further based on the location information, wherein the estimation of the at least one RRM metric is based on a machine learning, ML, model, the ML being trained based on the historical information.

33.-35. (canceled)

36. The method of claim 28, wherein the measurement report does not include RRM measurements.
